(19) United States
(12) Patent Application Publication
(10) Pub. No.: US 2005/0108574 A1
(43) Pub. Date: May 19, 2005

(54) Method and system for communication between a multi-modal device and a web application

(75) Inventors: Walter Haenel, Holzgerlingen (DE); Lars Mueller, Crivitz (DE)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/967,458

(22) Filed: Oct. 18, 2004

(30) Foreign Application Priority Data
Nov. 18, 2003 (EP) 03104240.1

(51) Int. Cl. H04L 9/00

(52) U.S. Cl. 713/201

(57) ABSTRACT

The present invention discloses a new communication infrastructure between a device and a web application that is extended by an inventive proxy. The proxy combines the functionality of each mode of communication of a single device, and presents it as a single device to the web application. This is achieved by the inventive session management of the proxy. The proxy generates for each mode of communication of a single device with the proxy an own single session identifier (ID). Communicating with the web application, the proxy uses only one common session for each single device independently which mode of communication is currently active. The common session is mapped to the respective session of the currently active mode of communication preferably by a common device identifier representing a single device. Each communication between Proxy and device is established by using the session ID of the respective mode of communication.

### FIELD OF THE INVENTION

The present invention relates to the communication of a multi-modal device with a web application in general, and more particularly to a method and system for switching between visual and voice communication of a multi-modal device with a portal application without loosing already existing session data.

The term “multi-modal device” (hereinafter called “device”) as used in the present invention means any data processing device as well as any phone or mobile phone having the capabilities to support voice as well as visual communication (mode of communication). Normally, such devices additionally include a screen, a visual browser, voice browser, and speech input/speech output means.

### BACKGROUND ART

A typical example for such a device is a mobile phone which supports voice and visual communication. However, any other device which has similar capabilities may be also be used.

Such devices can access a web application, e.g., a portal application, in at least in two modes of communication. A first mode of communication (e.g., voice communication) uses the device as a normal phone and accesses the web application via a telephone network (e.g., voice server; see FIG. 1)

The second mode of communication (e.g., visual communication) uses the device as a normal data processing device (e.g., a device that supports Wireless Application Protocol (WAP)) to access the web Application via an information processing network (e.g., a wireless gateway).

The visual communication of the device with a web application is preferably established via a WAP browser used by the device. Wireless Markup Language (WML) is preferably used to display the content of the web application. The device opens a connection to the wireless gateway. A session between the wireless gateway and web Application is then established (see FIG. 1).

The voice communication of a device with a web application is preferably established via a voice server that is connected by dialing a phone number and using a DNIS (Dialed Number Identification Server). By evaluating the phone number the voice server can determine the service to be requested and establishes a session with the web application. The web application responds for example with Voice XML (VXML) that is translated into voice by the voice server. Furthermore, the voice server is responsible for speech recognition (see FIG. 1).

Since the web application does not recognize that the two modes of communication are established via the same device, each mode of communication is assigned its own session data with the web application. The already existing session data generated by one mode of communication cannot be used by another mode of communication although the same device is used. The user has to initiate a new log-in procedure when switching from one mode to another mode of communication.

### SUMMARY OF THE INVENTION

The present invention improves the communication between multi-modal phones and web applications. The present invention discloses a new communication infrastructure between a device and a web application that is extended by a proxy. The proxy acts as a so-called representative. That means that the basic functionality of the proxy is to combine the functionality of each mode of communication of the same device, and to present it as single device to the web application. This is achieved by the inventive session management of the proxy. The proxy generates for each mode of communication of a single device its own session. Communicating with the web application, the proxy uses only one common session for each single device independently which mode of communication is currently active.

The sessions IDs are stored at the proxy. All session IDs belonging to the same device are assigned to each other. Each communication between proxy and device is established by using the appropriate session ID.

In a preferred embodiment, the web application is a portal application which additionally includes a portal filter. Since each request coming from the proxy contains a markup language identifier indicating the markup language supported by the currently active mode of communication, the portal filter reads the markup language identifier and informs the portal aggregation component to provide the information in a markup language determined by the markup language identifier.

In a further embodiment of the present invention, the information indicating the currently active mode of communication is included in the Accept-Field of the request.

In further embodiment of the present invention, the portal application additionally includes a portlet filter. The portlet filter provides the functionality to read the request from the proxy and to inform the portlet to provide the information in a markup language determined by the markup language identifier.

In further embodiment of the present invention, the proxy functionality is part of an external authentication proxy server. The authentication proxy server provides an authentication mechanism for accessing the web application. The authentication mechanism is extended by the inventive proxy functionality with its inventive session management. That means the authentication proxy transfers the authentication from one mode of communication to another mode of communication. The authentication proxy is the central instance for combining both modes of communication of the single device, and for managing the sessions with the respective networks (e.g., voice server; or data processing network (e.g., WML gateway). Furthermore, the authentication proxy ensures that only one session with the portal application is created. For the portal application there exists only one proxy.

In this embodiment the authentication proxy provides the functionality to keep only a single session with the web application, which is preferably a portal application, as long as one of the modes of communication of a single device is active, to transfer the authentication from one mode of communication to another mode of communication, and to update the user request according to the currently active mode of communication in order to switch from one mode of communication to another mode of communication.

The aggregation component which is preferably part of the portal application, is adapted to trigger the switch from one mode of communication to another mode of communication.

In a preferred embodiment a keyword in the voice representation of the portal application is provided, or in the visual representation of the portal application a button in the WAP version is presented. In this preferred embodiment the aggregation component provides the functionality to build up the markup language document around the markup fragments delivered by the portlets by selecting the correct markup version determined in the request by the markup language identifier, which can be WML or VXML, and changes the user interface in response to the keyword or a button pressed event depending on the mode of communication.

The proxy may be located on a separate proxy server having a connection link to the device and a connection to the web application, which is preferably a portal application.

In another implementation the proxy may be located at the same server that runs the web application.

Finally, the proxy could be implemented as a part of the web application itself.

A first aspect of the present invention is directed to a proxy for use in a communication infrastructure between a device and a web application, wherein the proxy includes a communication link to the web application and a communication link to the device, wherein the device allows switching from one mode of communication to another mode of communication with the web application, comprising: means for receiving requests from a currently active mode of communication of the device; means for assigning information indicating the currently active mode of communication to a common device ID representing the device; means for extending a request by a markup language identifier indicating a language supported by the currently active mode of communication; means for sending the extended request to the web. application; means for receiving information generated by the web application in a markup language indicated by the markup language identifier, including a common session ID for use in communication between the proxy and the web application; means for generating a single session ID for an assigned currently active mode of communication of the device, and means for transmitting the web information including the single session ID assigned to the currently active mode of communication to the currently active mode of communication of the device.

A second aspect of the present invention is directed to a proxy for use in a communication infrastructure between a device and a web application, wherein the proxy includes a communication link to the web application and a communication link to the device, wherein the device receives requests from a respective mode of communication and provides the requests to the web application, comprising: means for creating a single session for each active mode of communication of the proxy with the respective mode of communication of the device; means for using a common session for each device independently of which mode of communication is currently active; means for extending each request of the respective active mode of communication of the device by a markup language indicating the markup language supported by the currently active mode of communication; and means for providing information received from the web application to the respective active mode of communication by mapping the common session to the single active session belonging to the device.

A third aspect of the present invention is directed to a method for communication between a device and a web application, wherein the device has at least two modes of communication and each respective mode of communication communicates via a respective network and a proxy to the web application, wherein the method comprises the steps of: receiving requests from a currently active mode of communication; storing information indicating the currently active mode of communication; assigning the information to a common device ID representing the device; extending a request by a markup language identifier indicating a language supported by the currently active mode of communication; sending the extended request to the web application; receiving information generated by the web application in a language indicated by the markup language identifier, including a common session ID for use in communication between the proxy and the web application; assigning the common session ID to the common device ID; generating a single session ID for the currently active mode of communication of the device for use in communication between the respective mode of communication and the proxy and assigning the single session ID to the common device ID; and transmitting the web information including the single session ID assigned to the currently active mode of communication.

A fourth aspect of the present invention is directed to a portal application comprising: a communication link to a proxy connected to a device, the communication link providing requests via an active mode of communication to the portal application; a component for receiving requests from the proxy, including a markup language identifier indicating a language supported by the currently active mode of communication; a portal filter component for informing a portal aggregation component to provide portal information in a form determined by the markup language identifier included in the request; a portal aggregation component for providing the portal information in the form determined by the markup language identifier; a component for generating a common session with the proxy and for providing information including a common session ID to the proxy, wherein the proxy maps the common session ID to a respective single session of the proxy with the currently active mode of communication.

A fifth aspect of the present invention is directed to a communication infrastructure for providing web information to a device having a proxy server comprising: a communication link to each respective mode of communication of a device; means for creating a single session for each active mode of communication of the proxy with the respective mode of communication of the device; means for using a common session for each device independently of which mode of communication currently being used the device is active; means for extending each request of the respective active mode of communication of the device by a markup language identifier indicating a markup language supported by the currently active mode of communication; and means for providing information received from a web application to the respective active mode of communication by mapping the common session to the respective single active session belonging to the device.

A sixth aspect of the present invention is directed to a portal server including: a communication link to a proxy server; a component for receiving requests from a respective active mode of communication of a device from the proxy server including a markup language identifier indicating a language supported by a currently active mode of communication; a portal filter component for informing a portal aggregation component to provide portal information in a form determined by the markup language identifier included in the request; a portal aggregation component for providing the requested information in a language determined by the markup language identifier; and a component for generating a common session with the proxy and providing the information including the common session ID to the proxy, wherein the proxy maps the common session ID to the respective single session of the proxy with the respective currently active mode of communication.

### BRIEF DESCRIPTION OF THE DRAWINGS

The objectives, features, and advantages of the invention will be best understood by reference to the following detailed description of an illustrative embodiment when read in conjunction with the accompanying drawings, wherein:

FIG. 1 shows a prior art communication infrastructure between a device and a web application,

FIG. 2 shows a communication infrastructure including a proxy component in accordance with an embodiment of the present invention,

FIG. 3 shows a preferred embodiment of the present invention in a communication infrastructure with a portal application, and

FIG. 4, comprising FIGS. 4a and 4b, shows the inventive message flow in a portal environment according to FIG. 3.

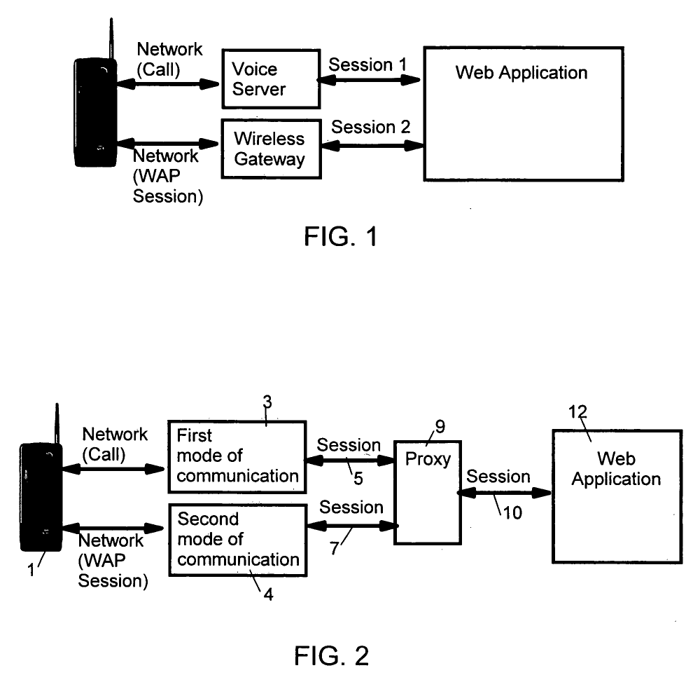

### DETAILED DESCRIPTION OF THE INVENTION

With regard to FIG. 2, there is depicted a communication infrastructure which includes a device and web application, and which includes a proxy component in accordance with an embodiment of the present invention.

The proxy 9 acts in the communication infrastructure as a so-called representative. That means that the basic functionality of the proxy 9 is to combine the functionality of each mode of communication 3, 4 of the device 1, and to present it as a single device 1 to the web application 12. This is achieved by the inventive session management of the proxy 9. The proxy 9 generates for each mode of communication 3, 4 of a single device 1 (e.g., one session with the voice server, one session with the WAP gateway) its own session 5, 7. Communicating with the web application 12, the proxy 9 uses only one common session 10 for each device independently of which mode of communication is currently active. That means that the proxy 9 acts like a single device from the web application point of view.

The session identifiers (IDs) are stored at the proxy 9. All session IDs belonging to the same device 1 are assigned to each other. This may be implemented by a table containing the three session IDs and a common device identifier which may be preferably the phone number (ANI). Each communication between proxy 9 and device 1 is established by using the respective session ID.

A request initiated by one mode of communication of the device 1 is received via a respective network by the proxy 9. If there is no session and no active switch request, the proxy 9 receives the request, activates the mode of communication 3, 4 by setting a reference to the active mode in for example a table, modifies the request by inserting the markup language identifier, replaces the device description by its own description, and sends that modified request to the web application 12. The web application 12 verifies the request, creates a session (common session), associates an initial state of the web application 12 to the request, builds up a view of the web application 12 state in a markup language identified by the markup language identifier, and includes the common session ID into the response to the proxy 9 containing that view. The proxy 9 receives that response, stores the common session ID delivered with the response, determines the active mode, creates a single session with that currently active mode, and returns the response via a respective network to the active mode of the device 1. The existing sessions between active mode of communication 3, 4 with the proxy 9, and proxy 9 and web application 12 are assigned to each other by a common device identifier.

In a preferred embodiment of the present invention, the web application performs an authentication check during processing of a request, and if successful, includes an authentication token in the following response. The proxy 9 stores that authentication token together with the session IDs. The proxy 9 inserts that authentication token into all requests to the web application 12 coming from the same device 1.

In another preferred embodiment of the present invention, the proxy 9 performs an authentication check during processing of a request, and if successful, an authentication token is computed. The proxy 9 stores that authentication token together with the session IDs. The proxy 9 inserts that authentication token into all requests to the web application 12 coming from the same device 1. Common means, e.g., sharing of cryptographic keys are used to validate the authentication token on the web application side.

The switch from one mode of communication to another mode of communication 3, 4 is initialized by the proxy 9 by receiving a switch request from the device 1. The switch request may be generated by a button or a voice command. The proxy 9 verifies the request and initiates a switch from one mode of communication to the other mode of communication 3, 4. The common device identifier is available for both modes of communications 3, 4. Each request of each mode of communication 3, 4 may contain its own mode of communication identifier which will be mapped to a common device identifier, that is, there is only one common device identifier for both modes of communications 3, 4. The proxy 9 receives the switch request from the device 1 via the respective mode of communication network 3, 4, and sends a notification (push proxy gateway) to the device 1 to initiate another mode of communication 3, 4 with the proxy 9. The device 1 initiates the selected mode of communication 3, 4, and sends a new request to the proxy 9 for continuing the already existing session. The proxy 9 receives the request, activates the new mode of communication 3, 4 by setting a reference to the active mode in a table, for example, modifies the request by inserting a markup language identifier, includes the session ID created for the communication between proxy 9 and web application 12, replaces the device description by its own description, and sends that modified request to the web application 12. The web application 12 verifies the request, associates the already existing session data of the previous mode of communication 3, 4 to the current request which represents the web application state, builds up a new view of the same web application state in a markup language identified by the markup language identifier, and generates a response to the proxy 9 containing that new view. The proxy 9 receives that response, determines the active mode of communication 3, 4, and returns the response via that network to the device. Concurrently, the proxy 9 establishes a new session with the new selected mode of communication 3, 4 of the device 1. All existing previous sessions with the same device 1 in another mode are automatically deleted when a switch of mode of communication 3, 4 is initiated.

In a preferred embodiment of the present invention, after a switch request has been initialized, the proxy 9 includes a one time password in its notification to the mode of communication 3, 4. This one time password has to be returned with the initiated request to the proxy 9. That mechanism secures that no un-authorized devices can take over the session with the proxy 9.

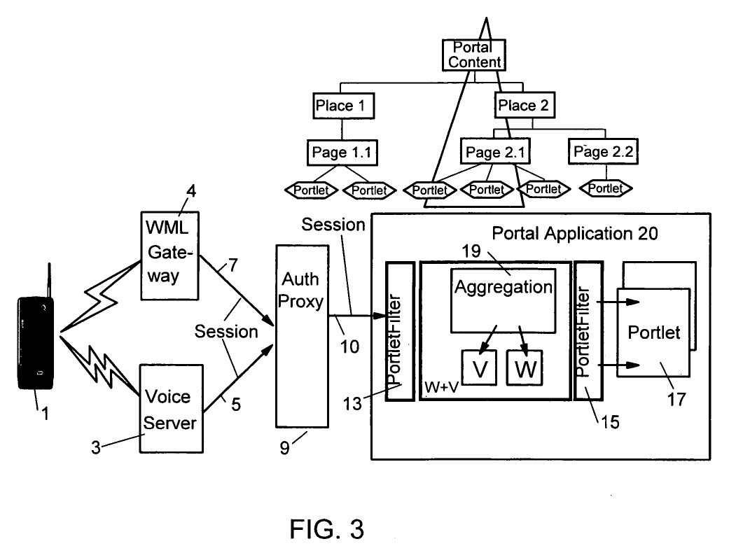

With respect to FIG. 3, there is depicted a preferred embodiment of the present invention in a portal application environment.

The device 1 is communicating with a portal application 20 via the inventive authentication proxy 9. The device 1 provides WAP and voice functionality. Each functionality of the device 1 provides its own mode of communication 3, 4. The authentication proxy 9 takes over the authentication of the device 1 with the portal application 20. The WAP and voice functionality of the device 1 is combined and presented as one device to the portal application 20.

This is achieved by the inventive session management of the authentication proxy 9. The session handling of the two modes of communications 3, 4 has to be synchronized. A voice request generated by the voice mode of communication is typically identified by the phone number the request comes from. This number is called ANI (Automatic Number Identification). The HTTP-Header of the WAP-request includes a user agent string which provides information about the device 1. The user agent string includes the phone number of the device 1. This number is the same as the ANI, hence mapping of both modes of communication by the authentication proxy is possible.

Three sessions are handled by the authentication proxy 9. One session with the WAP gateway 4, another session with the voice server 3, and a third session 10 with the portal application 20 which has to be forwarded to the active mode of communication of the device 1. These session IDs are stored at the authentication proxy 9, to assign them to each other. This is implemented by using a table containing the three session IDS, and the ANI to ensure that only one WML and VXML sessions are saved that come from the same device 1.

To avoid markup changes (e.g., from VXML to WML) within one session, a container markup is created. This container markup is not real markup; it is only implemented to offer a markup which supports both needed markups. This markup has no own definition but it has two subtypes or versions. One version is VXML, and the other is WML. With this container markup only the version of the markup has to be changed in a case of change of mode of communication. The aggregation component 19 of the portal application 20 reads the version which is included in the request and loads the portal information in the requested version.

The authentication proxy 9 in used to combine both modes of communications into one and to manage the session with the WML gateway 4 and the voice server 3. The authentication proxy 9 ensures that only one session with the portal application 20 is created.

The aggregation component 19 of the portal application 20 provides the functionality to trigger the change from one mode to another mode of communication. That can be implemented by providing a keyword in the voice presentation or a button in the WAP version. The aggregation component 19 builds up markup around the portlets 17 by selecting the right markup version contained in the appropriate request. The main functionality of the aggregation component 19 may be summarized as follows: it builds up the markup around the portlet 17 markup fragment, and selects the markup by the markup version which are WML and VXML. The portal application 20 further includes a portal filter 13. The portal filter 13 reads the markup version contained in a change request and informs the portal aggregation 19 component to provide that markup version required by the currently active mode of communication.

Another portlet filter 15 is responsible to wrap the VXML and WML capabilities of a portlet 17 into a W+V capability presented to the portal aggregation component 19. The main functionality of the portlet filter 15 includes adding the capabilities to support W+V to an “old” portlet 17, which is supporting WML and VXML but not the combined language W+V, and selecting the right content (either WML or voice) from an old portlet 17. The portlet filter 15 is not needed for portlets supporting W+V natively.

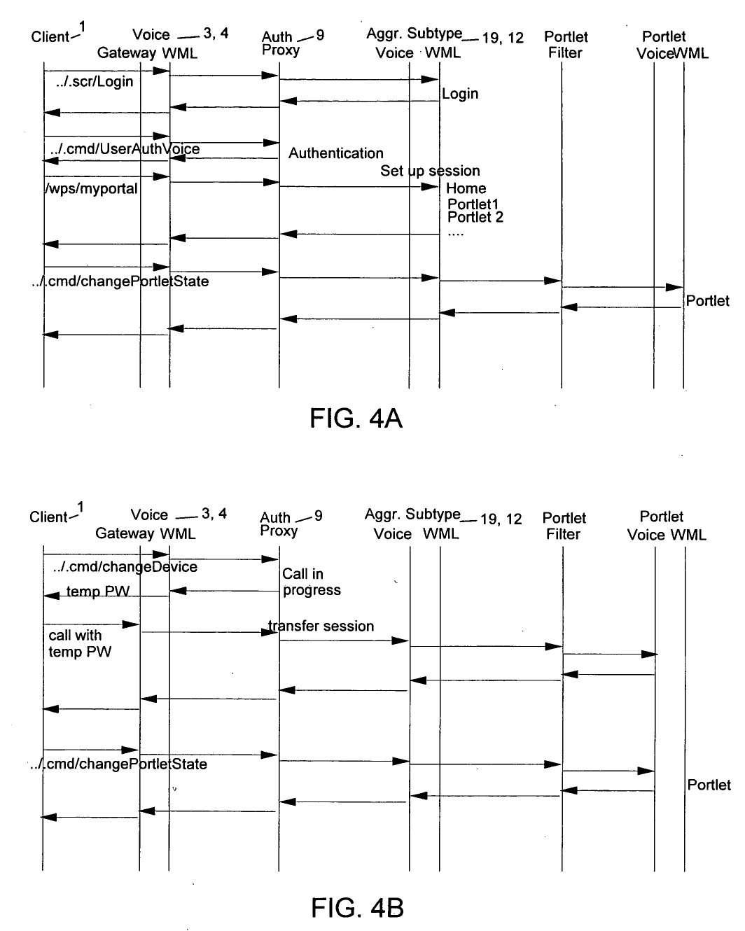

With respect to FIG. 4 (comprising FIGS. 4a and 4b), there is depicted the inventive message flow in a portal environment according to FIG. 3.

The WAP browser of the device 1 requests a logon procedure and is authenticated by the authentication proxy 9. The request is redirected to the portal application 20. A session is established and the WAP browser can now communicate with the portal application 20.

The device 1 sends a “switch” request which is intercepted by the authentication proxy 9. The authentication proxy 9 is responding by sending a phone number padded with a temp password. With this combined number the voice mode can dial to the voice server which forwards the request to the authentication proxy 9. The authentication proxy 9 recognizes the ANI and checks the appended password. The session is transferred to the voice server 3. The voice server 3 can continue the session of the WAP mode without further authentication by the portal application 20.

Communication Switch From Voice to WAP

The user makes a change device mode request (voice—WAP) activated by voice control (e.g., keyword command). This command is handled by the authentication proxy 9. The authentication proxy 9 generates a temp password and reads the phone number (ANI) from the request.

The ANI, the password, and the session ID are stored in the table described with respect to FIG. 3. A URL is generated which comprises the authentication proxy 9 address and the password.

The authentication proxy 9 waits for a voice confirmation before it pushes a WML document containing this link to the corresponding WAP mode. This connection is automatically switched and the user has to accept this link. By using this link the voice connection is terminated. The request to the pushed link from the WAP mode is received by the authentication proxy 9. The ANI is mapped to the stored session ID by using the session table. The password parameter of the link is used to verify the session is valid. The authentication proxy 9 can now switch the connection to the WAP mode device ID. The authentication proxy 9 requests the new markup from the portal application 20 and returns the portal response to the WAP mode. The session transfer is complete.

Communication Switch From WAP to Voice

The user sends a change mode request (WAP—voice) activated by the WAP control. This could be triggered by a button or link. The authentication proxy 9 processes the requests, reads the ANI from the user agent string, and generates a temp password. The ANI and the password are stored in a session table entry for this session. A call-in number (DNIS) is generated that comprises two parts: voice server number and password. A WML document with a WTAI link to this number is created. If the user accepts the link, the WML connection is terminated and the phone line activated. The password is attached to the DNIS. The authentication proxy 9 maps the ANI to the session ID. The password part of the DNIS is used to verify the session is valid. The authentication proxy 9 retrieves the portal session ID from the table and switches the user agent string to the voice device ID. The authentication proxy 9 requests the new markup from the portal application 20 and returns the response of the portal application 20 to the voice gateway 3. The voice connection is now active.

1. A proxy for use in a communication infrastructure between a device and a web application, wherein the proxy includes a communication link to the web application and a communication link to the device, wherein the device allows switching from one mode of communication to another mode of communication with the web application, comprising:
means for receiving requests from a currently active mode of communication of the device;
means for assigning information indicating the currently active mode of communication to a common device ID representing the device;
means for extending a request by a markup language identifier indicating a language supported by the currently active mode of communication;
means for sending the extended request to the web application;
means for receiving information generated by the web application in a markup language indicated by the markup language identifier, including a common session ID for use in communication between the proxy and the web application;
means for generating a single session ID for an assigned currently active mode of communication of the device, and means for transmitting the web information including the single session ID assigned to the currently active mode of communication to the currently active mode of communication of the device.

2. Proxy according to claim 1, further comprising:
means for authentication of the device.

3. Proxy according to claim 1, further comprising:
means for switching from the currently active mode of communication to another mode of communication of the device.

4. Proxy according to claim 3, wherein the means for switching determines a switch request generated by the device, and sends a notification request to the device to initiate the another mode of communication of the device.

5. Proxy for use in a communication infrastructure between a device and a web application, wherein the proxy includes a communication link to the web application and a communication link to the device, wherein the device receives requests from a respective mode of communication and provides the requests to the web application, comprising:
means for creating a single session for each active mode of communication of the proxy with the respective mode of communication of the device;
means for using a common session for each device independently of which mode of communication is currently active;
means for extending each request of the respective active mode of communication of the device by a markup language indicating the markup language supported by the currently active mode of communication; and
means for providing information received from the web application to the respective active mode of communication by mapping the common session to the single active session belonging to the device.

6. Proxy according to claim 5, further comprising:
means for authentication of a user of the device.

7. Method for communication between a device and a web application, wherein the device has at least two modes of communication and each respective mode of communication communicates via a respective network and a proxy to the web application, wherein the method comprises the steps of:
receiving requests from a currently active mode of communication;
storing information indicating the currently active mode of communication;
assigning the information to a common device ID representing the device;
extending a request by a markup language identifier indicating a language supported by the currently active mode of communication;
sending the extended request to the web application;
receiving information generated by the web application in a language indicated by the markup language identifier, including a common session ID for use in communication between the proxy and the web application;
assigning the common session ID to the common device ID;
generating a single session ID for the currently active mode of communication of the device for use in communication between the respective mode of communication and the proxy and assigning the single session ID to the common device ID; and
transmitting the web information including the single session ID assigned to the currently active mode of communication.

8. Method according to claim 7, wherein the common device identifier is derived from an incoming request.

9. Method according to claim 7, wherein the currently active mode of communication is derived from an incoming request.

10. Method according to claim 7, wherein an incoming request initiates an authentication process, and wherein information regarding a successful authentication is assigned to the common device ID and is used in requests generated by the device.

11. Method according to claim 7, wherein a change of mode of communication is secured by a password.

12. Method according to claim 7, further comprises the steps:
determining a switch request for switching from one mode of communication to another mode of communication;
sending a notification to the device for initiating switching to another mode of communication;
receiving a request from a newly active mode of communication;
assigning the newly active mode of communication to the existing common device ID;
extending the request by a new markup language identifier indicating a language supported by the currently active mode of communication;
sending the extended request to the web application, including the common session ID assigned to the common device ID;
receiving information generated by the web application in a language indicated by the mode of communication identifier;
generating a new single session ID for the currently active mode of communication of the device for use in communication between the respective mode of communication and the proxy and assigning it to the common device ID; and
transmitting the web information including the single session ID assigned to the currently active mode of communication to the currently active mode of communication of the device.

13. Method according to claim 7, wherein one mode of communication is voice communication using VoiceXML and another mode of communication is visual communication using XML.

14. Method according to claim 7, wherein the web application is a portal application.

15. Computer program product stored in the internal memory of a digital computer, containing parts of software code to execute the method in accordance with claim 7 when run on the computer.

16. Portal application comprising:
a communication link to a proxy connected to a device, the communication link providing requests via an active mode of communication to the portal application;
a component for receiving requests from the proxy, including a markup language identifier indicating a language supported by the currently active mode of communication;
a portal filter component for informing a portal aggregation component to provide portal information in a form determined by the markup language identifier included in the request,
a portal aggregation component for providing the portal information in the form determined by the markup language identifier;
a component for generating a common session with the proxy and for providing information including a common session ID to the proxy, wherein the proxy maps the common session ID to a respective single session of the proxy with the currently active mode of communication.

17. Portal application according to claim 16, further including a portlet filter for reading the markup language identifier included in the request from the proxy and for informing the portlet to provide information in a markup language determined by the markup language identifier.

18. Communication infrastructure for providing web information to a device having a proxy server comprising:
a communication link to each respective mode of communication of a device;
means for creating a single session for each active mode of communication of the proxy with the respective mode of communication of the device;
means for using a common session for each device independently of which mode of communication currently being used the device is active;
means for extending each request of the respective active mode of communication of the device by a markup language identifier indicating a markup language supported by the currently active mode of communication; and
means for providing information received from a web application to the respective active mode of communication by mapping the common session to the respective single active session belonging to the device.

19. A portal server including:
a communication link to a proxy server;
a component for receiving requests from a respective active mode of communication of a device from the proxy server including a markup language identifier indicating a language supported by a currently active mode of communication;
a portal filter component for informing a portal aggregation component to provide portal information in a form determined by the markup language identifier included in the request;
a portal aggregation component for providing the requested information in a language determined by the markup language identifier;
a component for generating a common session with the proxy and providing the information including the common session ID to the proxy, wherein the proxy maps the common session ID to the respective single session of the proxy with the respective currently active mode of communication.
